(19) United States
(12) Patent Application Publication
(10) Pub. No.: US 2015/0161874 A1
(43) Pub. Date: Jun. 11, 2015

(54) CLOSE PROXIMITY RFID TAG AND MONITORING SYSTEM

(71) Applicant: Hand-Scan, LLC, Pittsford, NY (US)

(72) Inventors: Louis E. Thyroff, Pittsford, NY (US); John M. Price, San Jose, CA (US)

(21) Appl. No.: 14/567,902

(22) Filed: Dec. 11, 2014

Related U.S. Application Data
(60) Provisional application No. 61/914,754, filed on Dec. 11, 2013.

(51) Int. Cl. G08B 21/24; G08B 25/10

(52) U.S. Cl. CPC G08B 21/245; G08B 25/10

(57) ABSTRACT

A system for monitoring hand washing compliance that includes a plurality of sensors installed in a space to detect the presence of or proximity of personnel to key areas; and a controller operatively coupled to the sensors, the controller being programmed to analyze sensor inputs to determine if personnel are washing their hands in a manner compliant with a set of requirements, and a networked data storage and reporting system operatively coupled to the controller and configured to provide reports of hand washing compliance. The sensors are installed on a ceiling over the space and an LED light illuminates a hand washing area for an interval of time that begins in response to detection by one of the plurality of sensors that a user is in proximity to the sink and ends when hand washing compliance is complete.

### BACKGROUND

1. Technical Field

The present disclosure pertains to monitoring systems utilizing radio frequency identification tags as well as motion and IR sensors and, more particularly, to a radio frequency transponder located in close proximity to the human body for use in a ceiling-mounted hand wash monitoring system.

2. Description of the Related Art

Studies have shown that up to one-half of all men and at least a quarter of all women fail to wash their hands after using restroom facilities, such as the toilet. Statistics are far worse for teenagers, children, and even young adults. Overall, approximately 97% of foodborne illnesses in the United States have been attributed to improper food handling in commercial and non-commercial environments. This means that over 70 million Americans contract a foodborne illness each year, resulting in 325,000 hospitalizations and 5,000 deaths. The Center for Disease Control (CDC) indicates that at least 25% of these cases are due to improper and inadequate hand washing. The annual cost to deal with food-borne illness was estimated to cost $35 billion in the U.S each year. This included medical charges, lost wages, lost business, lawyer fees, and legal claims.

The CDC advises that hand washing is the single most important means of preventing the spread of infection. Effective personal hygiene, especially hand washing, is critical at every stage of food production, preparation, and serving.

Under the law, commercial food handling requires compliance with certain requirements. It is important for companies to understand the risk imposed by these laws and the risk for failure to comply. Employees are required by state and federal law to wash their hands with soap and water after using the restroom. Statistics show that lawsuits are on the rise as are legal costs, settlement costs, and adverse judgments. In many states, the doctrines of strict liability and constructive knowledge expose the individual owners of these companies to liability, regardless of fault and knowledge.

Today, there are approximately 340,000 Quick Serve Restaurants (QSR) in the United States serving over 50 million Americans daily. It is estimated there are over one million QSRs worldwide.

Effective hand hygiene has been shown to be the most effective means for interrupting the transmission of viruses and bacteria. There is a need for a standard device to monitor employee compliance with a hand washing regime in the workplace and for tracking which employees are complaint and for generating statistics to enable management intervention when needed. Studies have shown that over 50% of food workers do not follow safe hygiene practices. The most common transmission of stomach virus and foodborne illnesses occurs through unwashed or inadequately washed hands. At least 1 in every 6 people in the United States will experience a foodborne illness from unclean hands each year.

Radio Frequency Identification (RFID) devices or “tags” have found their way into use in the monitoring of hygiene in various industries. RFID devices have also been used in inventory tracking and control as well as security to prevent or deter theft from shoplifting. The typical use is a tag attached with a cumbersome housing directly on the clothing that must be removed at the time of purchase. Such security applications can be undesirable where the attachment of the tag to the clothing damages the material or where the tag is forgotten and the purchaser either sets off the alarm or returns home to find the tag still attached to the clothing and unwearable. The use of RFID tags in association with clothing that is worn and then repeatedly laundered presents additional unique issues beside the problems discussed above with respect to the impact of the human body on tag performance. Attaching a tag to clothing that will be worn laundered with the tag attached requires a means of attachment that does not interfere with the comfort of the clothing, that is reliable and robust and will not fail during wear and cleaning, protects the tag while allowing for flexing and bending of the tag.

In operation, RFID devices act as transponders (generally referred to as “tags”), providing information stored in an associated semiconductor device in response to an interrogation signal received at the antenna from a reader or interrogator. The interrogation signal is usually in the form of a radio-frequency (RF) carrier wave signal without, or without, encoded information (e.g., modulated). The information stored on the tag may include a unique identifier of the RFID device, such as a unique serial number (e.g., alpha-numeric), or information (e.g., account, manufacturer, model, style, size, weight, price, color, etc.) about the item to which the RFID device is attached or otherwise associated or about a person who may be wearing the RFID device.

RFID devices that include a discrete power source, for example a battery, are commonly referred to as active devices. RFID devices that rely on an RF signal to derive power are commonly referred to as passive devices, which typically employ modulation backscatter techniques. Some RFID devices may employ both active and passive power sources.

Identification of passive RFID devices generally depends on RF energy produced by a reader or interrogator arriving at the RFID device, which backscatters modulated RF energy to the interrogator to convey the information stored in the RFID device or tag. In general, lower frequencies can penetrate objects better than higher frequencies, but higher frequencies can carry more data than lower frequencies. In addition, multiple protocols exist for use with RFID devices. These protocols may specify, among other things, particular frequencies, frequency ranges, modulation schemes, security schemes, and data formats. Conventional approaches employ multiple RFID devices, each RFID device using a frequency band and protocol suited to a particular application.

Currently, there are passive RFID tags with single or multiple antennas that receive interrogation signals from a reader or interrogator via the antenna(s). The RF voltage developed on the antennas is converted to DC voltage, thereby generating enough power for the RFID tag to power up and transmit a response. Transmitting the response takes the form of backscattering modulated interrogation signals via the antenna(s). Most tag antennas are designed for a specific application, generally referred to in the art as “tuned” to the environment in which it is used. Tags that are brought into contact with the human body or near to the human body will “detune” and not receive interrogation signals due to a coupling effect with the human body.

When a tag is used on or near the human body, its receptive characteristics are diminished due to signal absorption caused by the conductivity of the human body. In other words, because of the size of the human body and its electrostatic characteristics, such as tissue texture, high permittivity, and power absorption, the gain of the tag's antenna will be lowered, reducing its receptivity to interrogation signals and its effective range.

Various approaches have been taken to designing a tag that is “tuned” to receive interrogation signals. In UHF RFID Tag Antenna Design for On-Body Applications by Ziai and Batchelor (2010 Loughborough Antennas *& Propagation Conference, 8-9 Nov. 2010), proposes a slot antenna design on a PET substrate using etched copper, although this design is for 867 Mhz operations. In UHF RFID PIFA Array Tag Antenna for Human Body Applications by Tsai, Li, Chiu, and Wang, an involves a structure consisting of 4 symmetrical small patch antenna arrays formed of planar inverted-F antennas (PIFA's) built on an FR4 substrate. This design relies on grounded vias to enhance directive gain. U.S. Patent Application Publication No. 2006/0054710 (“Forster et al.”) proposed an RFID tag using a self-compensating antenna and conductive shield. Forster et al. utilize an antenna design that has compensation elements, such as impedance matching between the antenna and a chip or components that change the effective length of the antenna elements, so the antenna stays in or near a resonant condition. U.S. Pat. No. 7,323,994 (Yamagajo et al.”) describes an RFID tag formed of two superimposed RFID tags having 13.56 Mhz overlapping coiled stacked resonator loops. W02011005550A2 (“Isabell”) proposes an RFID device for tracking clothing in which a conductive thread is used as a radiating structure to enhance the read range of the tag formed in a button. U.S. Pat. No. 7,999,683 (“Fein”) provides an RFID card style tag that may accept a lanyard.

It is therefore desirable to have a passive or partially passive RFID device and method for backscattering modulated signals via one or more antennas that is tuned to operate in close proximity to the human body, such as on a name tag applied to clothing or on a tag integrally formed with clothing, to ensure the RFID tag receives sufficient power to continue functioning with maximum range.

### BRIEF SUMMARY

The present disclosure is directed to an RFID system and monitoring method designed for use in close proximity to the human body, preferably in the context of monitoring and tracking hand washing. The present disclosure is also applicable to point of purchase security, inventory control, and other applications where the RFID transponder or tag is worn on the exterior of the clothing or is integrally formed with fabric, such as clothing, and when worn in near proximity to the human body, the antenna is tuned to respond to interrogation signals.

In accordance with one aspect of the present disclosure, a system for monitoring hand washing at a hand washing station having a sink and a soap dispenser is provided that includes an interrogator located in a ceiling in proximity to the hand washing station and configured to transmit interrogation signals and to receive responsive backscattered signals and to transmit data signals to the processor and the memory; a first sensor located in the ceiling above the soap dispenser and structured to detect the presence of the user's hands in close proximity to the soap dispenser; a second sensor located in the ceiling above the sink and structured to detect the presence of the user's hands in close proximity to the sink; a high intensity LED spotlight located in the ceiling above the sink and structured to visibly illuminate the sink for an interval of time in response to detection of the user by the second sensor; an RFID tag configured to be worn on or in close proximity to a user's body, the tag including: a radio frequency circuit configured to receive and modulate an interrogation signal for backscatter transmission; and an antenna configured to resonate in response to the interrogation signal when in close proximity to the human body. The system further includes a computer processor coupled to the interrogator and configured to receive the data signals from the interrogator to determine a presence of the user and to process the same and generate reports pertaining to use of the hand washing station by users, the computer processor further coupled to the LED light and configured to control the interval of time the LED light illuminates the sink.

In accordance with another aspect of the present disclosure, the computer processor is configured to provide audio or visual feedback to the user indicating compliance with hand washing procedures in response to input from the first and second sensors.

In accordance with another aspect of the present disclosure, a system is provided for monitoring hand washing compliance, the system including a plurality of sensors installed in a space to detect the presence of or proximity of personnel to key areas; and a controller operatively coupled to the sensors, the controller being programmed to analyze sensor inputs to determine if personnel are washing their hands in a manner compliant with a set of requirements, and a networked data storage and reporting system operatively coupled to the controller and configured to provide reports of hand washing compliance.

In accordance with one aspect of the present disclosure, an RFID transponder is provided that includes an antenna configured to resonate in response to an interrogation signal when in close proximity to the human body. Ideally the RFID transponder is associated with a name plate or other device worn on clothing that is attached with a metal pin.

In accordance with another aspect of the present disclosure, an RFID transponder is provided that is configured to respond to an interrogation signal when attached to a name plate or other device having an attachment pin for wearing near the human body. Ideally the transponder antenna is tuned to respond to an interrogation signal when the transponder antenna is RF coupled to the pin and the pin is in close proximity to the human body.

In accordance with yet a further aspect of the present disclosure, an RFID system is provided that utilizes an RFID tag with an antenna configured to be tuned for reception of an interrogation signal when integrally formed on clothing worn in close proximity to the human body. In one embodiment, the system is implemented in a hand washing monitoring station.

In accordance with yet another aspect of the present disclosure, a hand washing monitoring system is provided that includes an RFID system having a tag with an antenna tuned for reception of an interrogation signal when worn on a name tag attached to clothing on the human body.

In accordance with another aspect of the present disclosure, the foregoing hand washing station is configured to generate statistics for each individual who is required to utilize a hand washing station. Preferably, the present disclosure is implemented as a web application utilizing RFID technology to assist employees in compliance with public health regulations and to assist employers in managing employee compliance. Employees receive feedback on hand washing duration and the use of soap or disinfectant, and they can receive feedback in the form of a history of compliance and non-compliance.

In accordance with one aspect of the present disclosure, the method includes sensing the presence of a radio-frequency identification device, such as a tag, when worn in close proximity to the human body and within in a defined area around the hand washing station; identifying an individual associated with the RFID tag; detecting soap dispenser activity; initiating a first audible alert in response to a timer; initiating a second audible alert in response to expiration of a timer.

In accordance with another aspect of the present disclosure, the method includes storing data identifying the individual associated with the RFID tag, and generating and storing data regarding employee identification, location of wash station, compliance rate, wash time, average wash time, and compliance status.

In accordance with a further aspect of the present disclosure, a system is provided that includes an RFID tag configured to be worn on clothing or integrally formed with the clothing and having an antenna configured to be RF coupled to the skin of the employee, at least one reader configured to detect the presence of the RFID tag when RF coupled to the skin of the employee, at least one activation device configured to activate the RFID device when the RFID device is within an activation area, a skin disinfectant medium dispenser configured to dispense the disinfectant medium and to transmit a dispensing signal in response to dispensing the disinfectant medium, and a remote processor and associated memory with user interface coupled to the at least one reader, the at least one activation device, and the dispenser and configured to store data related to employee identification, location of wash station, compliance rate, wash time, average wash time, and compliance status, and to process the data to enable employer management of employee hand washing.

In accordance with a still yet another aspect of the present disclosure, a system is provided that includes an RFID tag configured to be worn on clothing or integrally formed with the clothing and having an antenna configured to be RF coupled to the skin of the employee, at least one reader or interrogator configured to detect the presence of the RFID tag when RF coupled to the skin of the employee and to activate the RFID tag when the RFID tag is within an activation area, a skin disinfectant medium dispenser configured to dispense the disinfectant medium and to transmit a dispensing signal in response to dispensing the disinfectant medium, and a remote processor and associated memory with user interface coupled to the at least one reader, the at least one activation device, and the dispenser and configured to store data related to employee identification, location of wash station, compliance rate, wash time, average wash time, and compliance status, and to process the data to enable employer management of employee hand washing.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an illustration of a known Radio Frequency Identification (RFID) system employing an RFID transponder or tag and an RFID interrogator or reader;

FIG. 2 is an illustration of the known RFID tag of FIG. 1.

FIG. 3 is a side view of an RFID name tag formed in accordance with the present disclosure and configured for attachment to or integral formation with a name plate having a metal pin;

FIG. 4 is a layout view of an RFID antenna formed in accordance with the present disclosure for use with the RFID name tag of FIG. 3;

FIG. 5 is an illustration of an RFID fabric tag formed in accordance with the present disclosure;

FIG. 6 is a layout view of an RFID antenna formed in accordance with the present disclosure for use with the RFID fabric tag of FIG. 5;

FIG. 7 is a front layout view of an alternative RFID antenna for use with the RFID fabric tag of FIG. 5;

FIG. 8 is a rear layout view of the antenna of FIG. 7;

FIGS. 9A and 9B are illustrations of hand washing monitoring systems formed in accordance with the present disclosure;

FIGS. 10-14 illustrate screen displays created by the system of FIG. 9 in accordance with the present disclosure;

FIGS. 15A-15B illustrate different configurations of an LED spotlight for use with the system of the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with RFID readers, passive power supply circuits, front-ends, memories, packaging, interrogators, sensors, dispensers, computers and computer processors have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

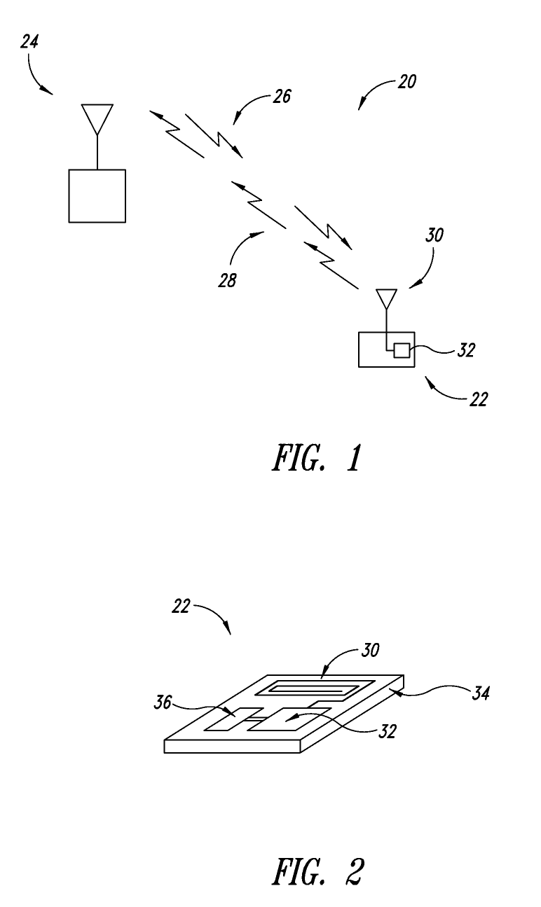

FIG. 1 shows a known RFID system 20 that includes an RFID device, such as a transponder or tag 22 and a remote carrier wave source such as an interrogator or reader 24. The interrogator 24 is operable to transmit carrier waves 26 that the RFID tag 22 returns as backscattered carrier wave responses 28. In at least some embodiments, the RFID tag 22 modulates and backscatters the carrier waves 26 received from the interrogator 24 as the reflected carrier wave responses 28.

As stated, the interrogator 24 may take the form of an RFID reader or interrogator that is readily commercially available in the automatic data collection field (ADC), and these are typically employed for reading from or writing to RFID tags. The interrogator 24 may transmit the carrier waves 26 as un-modulated carrier waves, or may transmit the carrier waves 26 as un-modulated carrier waves interspersed with modulated carrier waves.

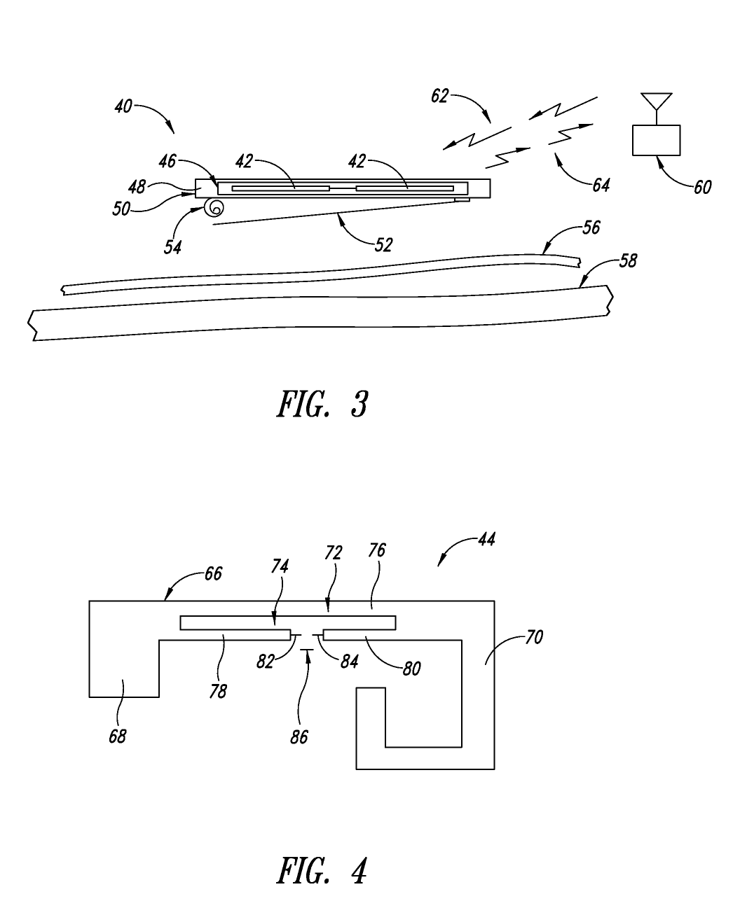

The RFID tag 22 has at least one antenna 30 and an RFID circuit 32 carried by a substrate 34 as shown more clearly in FIG. 2. The antenna 30 may be external to the tag and electrically coupled to the circuit 32 or it may be integrally formed with the circuit 32 on the same substrate 34. As discussed in more detail below, the RFID tag 22 is in this example operable to derive power from the carrier wave 26 transmitted by the interrogator 24, which is separate and distinct from the RFID tag 22.

The antenna 30 may be shaped and otherwise configured to receive and transmit at or within a frequency range emitted by the interrogator 24. For example, the antenna 30 may have a serpentine shape, crenulated shape, coil or volute shape, or a dipole T-shape or dipole opposing L-shape. The antenna 30 may include more than one antenna elements, for example one or more active antenna elements or one or more passive or parasitic antenna elements. Although numerous suitable antenna shapes and structures are known in the RFID art, they suffer from the inability to stay tuned to the interrogator frequency when near the human body.

In passive antenna designs, a radio frequency (RF) voltage is produced across the leads of the respective antenna 30 upon receipt of the carrier waves 26. The RFID circuit includes a passive power supply circuit 36. As used herein and in the claims, the term “passive power supply circuit” and variations of such mean a circuit that derives power via incident electromagnetic energy, such as energy from the radio frequency or microwave portions of the electromagnetic spectrum. The passive power supply circuit 36 may take the form of one or more integrated circuits or chips. Integrated circuits or chips suitable for use in some RFID applications are commercially available.

The passive power supply circuit 36 may include one or more front ends coupled to the antenna 30. For example, the passive power supply circuit 32 may include a respective front end for each antenna 30. As is well known in the RFID arts, the front end is configured to rectify the RF voltage produced across the leads of the respective antenna 30 to provide power to the RFID tag 22. The front end is configured to modulate the carrier wave responses 28, for example via load modulation for near field applications or varying the impedance of the respective antenna 30 for far field applications such as when providing the carrier wave responses 28 via backscattering.

The antenna 30 shown in FIG. 2 is a well-known loop design. Other designs are also known, as discussed above. However, when the tag 22 is used in close proximity to the human body, such as on a name tag or embedded in clothing worn on the human body, the antenna 30 can detune, as described above.

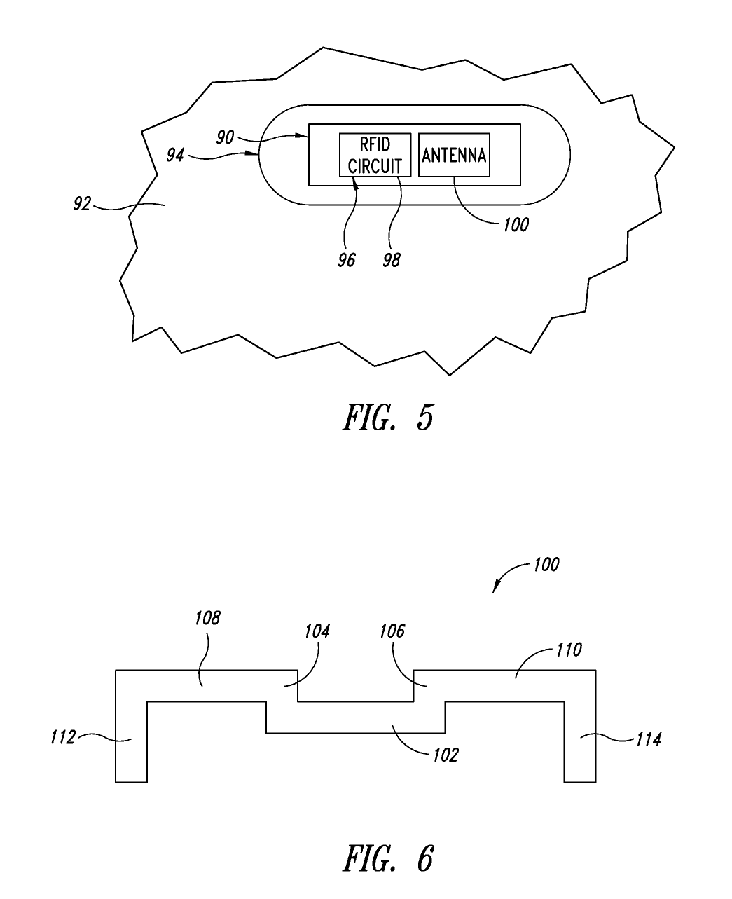

In accordance with the present disclosure an antenna design is provided for use with a name tag worn on clothing associated with the human body. Shown schematically in FIG. 3 is an RFID name tag 40 in which an RFID circuit 42 and associated antenna 44 are formed on a substrate 46 that is attached to or integrally formed with the body 48 of a name tag 50. Extending from one side of the tag 50 is a metal pin 52 and metal pin clasp 54 that holds the pin 52 in engagement with clothing 56 worn on a human body 58. An interrogator 60 is configured to transmit an interrogation signal 62 to the antenna 44 for reception and processing by the RFID tag circuit 42, which returns a reflected, modulated signal 64. Ideally the tag 40 is a passive tag as described above, although it may be configured as a semi-passive or fully active tag.

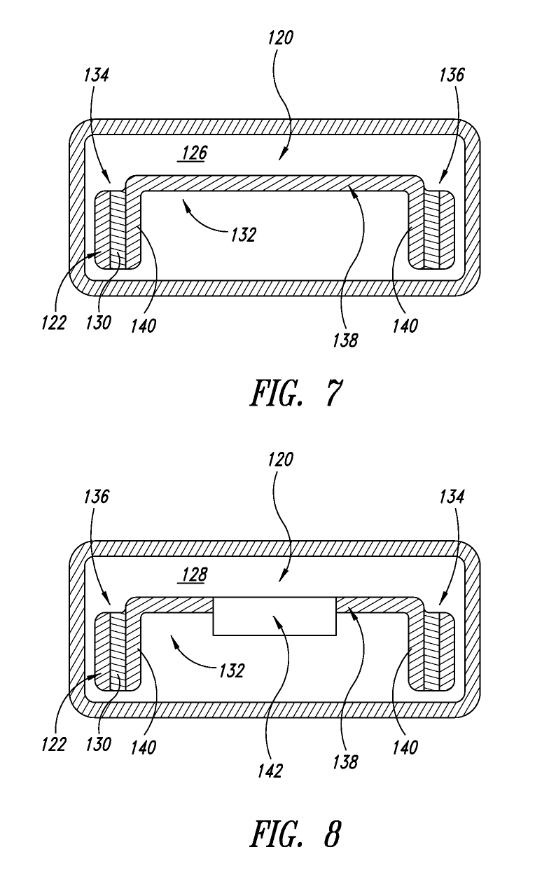

Because of the presence of the metal pin 52 and pin clasp 54, as well as the near proximity of the human body 58 when the tag 40 is worn on the clothing 56, the antenna 44 must be designed to receive the interrogation signal 62. FIG. 4 is a top plan view in layout orientation of the antenna 44, which in this case is designed for use in a 915 MHz environment. The antenna layout 44 includes the main body 66 formed of metal inlay or copper trace having a substantially rectangular first leg 68, a substantially inverted C-shaped second leg 70 attached at opposing ends to a transverse trace 72. The transverse trace 72 has an open interior space 74 defined by a top transverse portion 76 and two mutually opposing lower extensions 78, 80 that have respective terminal ends 82, 84 in the form of connection pads that project towards each other but do not touch. Positioned below the terminal ends 82, 84 is a ground pad 86. The antenna 44 is constructed using known photo-etch techniques, which will not be described in detail herein. The antenna is designed for linear polarization with the electrical field parallel to the floor. When worn, the name tag is assumed to be located over the pectoralis major, i.e., the front of the human chest.

Because the name tag 50 is typically worn on the user's clothing on the front of the body, generally adjacent the chest, the antenna 44 design is configured to accommodate signal reception at this location. The substrate 46 can be used in a flip-chip configuration or the name tag can utilize a strap insertion. The antenna will cooperate with the skin or flesh of the user to obtain and respond to an interrogation signal.

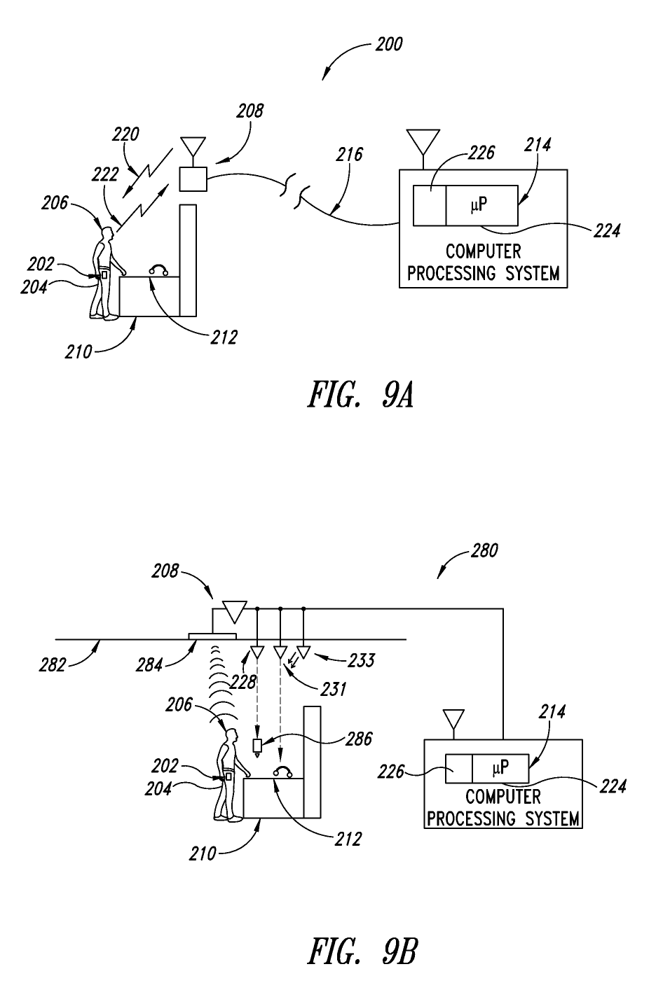

In accordance with another aspect of the present disclosure, an alternative antenna design is provided for use on clothing, preferably in the form of a sewn-on or iron-on patch. FIG. 5 depicts in schematic form an RFID fabric tag 90 formed on a portion of fabric cloth 92. The tag 90 may be encapsulated in a protective pouch 94 that is either sewn on or adhesively attached to the fabric 92, such as with an iron-on adhesive. In order to protect the tag from the heat of an iron as well as from repeated washing and ironing or steam pressing, the protective pouch 94 is at least water resistant and preferably formed of water proof material. The tag 90 includes RFID circuitry 96 mounted on a substrate 98 and electrically coupled to an antenna 100. Alternatively, no pouch is used but the area around the tag and corresponding chip should be encapsulated. Also, a second layer can be used to protect the tag inlay from directly touching external elements can be used. To permit flexing of the tag, the resonator loop with chip and the tag antenna will be two unique parts. Preferably, the antenna is aluminum etch and not physically connected to the resonator loop, rather inductive coupling is used.

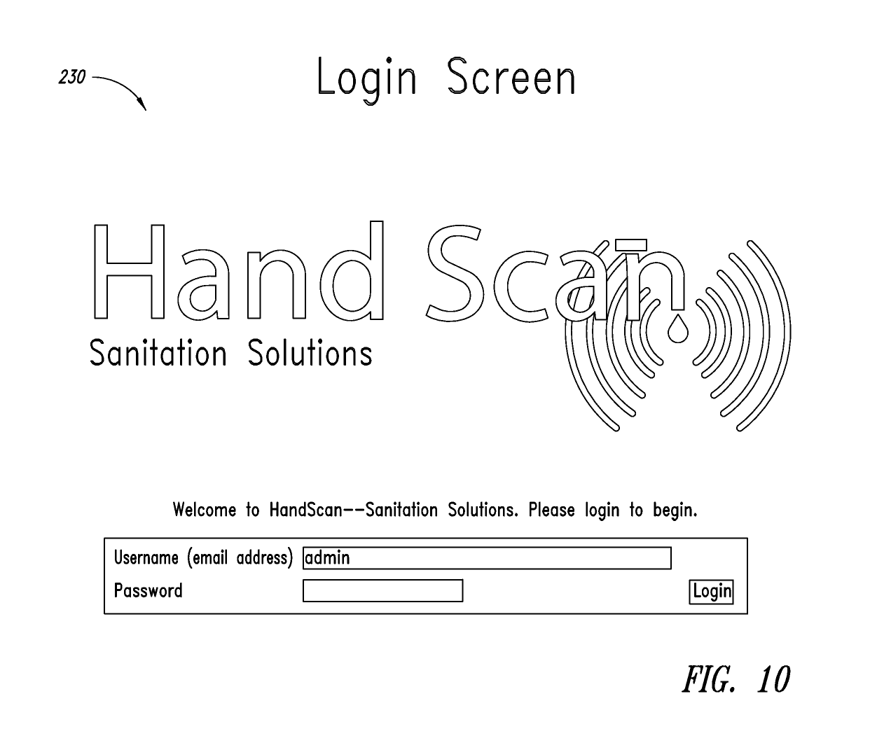

FIG. 6 illustrates the layout orientation of the antenna 100 for this form of use. As shown therein, the antenna 100 consists of a transverse main body 102 have two short upwardly projecting legs 104, 106 of the same height at each end. Extending outward from the top portion of each leg 104, 106, are left and right arms 108, 110, respectively, that are each of the same length. At the terminal end of each arm 108, 110 is a side leg 112, 114 that extends downward from the respective arm 108, 110, each leg 112, 114 being of the same length.

In a preferred embodiment, the antenna 100 is formed of metal inlay of about 5.0 mm in width throughout the entire antenna structure. It is to be understood that the antenna 100 can be made threaded metal or weaved metal thread. The main body 102 has a width of about 33.0 mm from each of the exterior lower corners, leaving the top width 23.0 mm. Each arm 108, 110 has a width along the top side of 33.0 mm, leaving the bottom side to have a width of 23.0 mm. Each side leg 112, 114 has an overall outside length of 20.0 mm and inside length of 15 mm. As will be appreciated from the foregoing and the accompanying illustration in FIG. 6, the antenna 100 is symmetrical about a vertical axis bisecting the main body. Ideally, the RFID circuit is inductively coupled to this antenna 100. For example, the RFID circuit is placed immediately above the transverse main body 102 between two short upwardly projecting legs 104, 106.

In this embodiment, impedance matching was done with an NXP chip UCode 7, with approximately 12 +j167 impedance. The read range for this tag is about 4 meters. If used with shorter adults, children, or even animals, the tag may have a reduced range. Because the system is designed to a 10 dB margin, items such as jewelry or a cell phone should not affect the tag's range or operational characteristics.

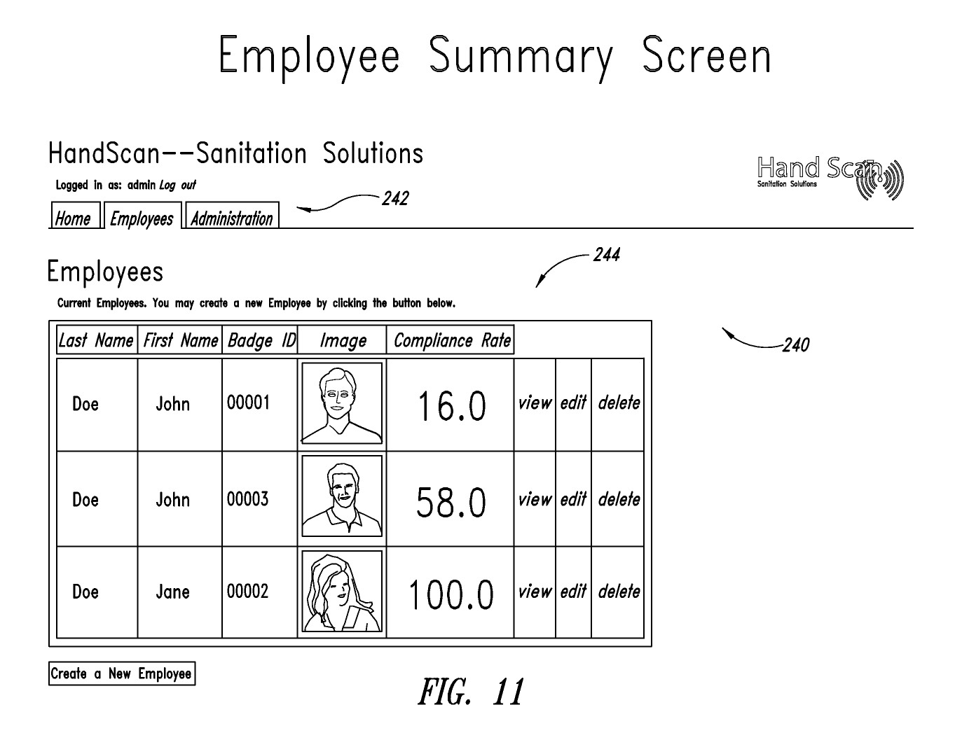

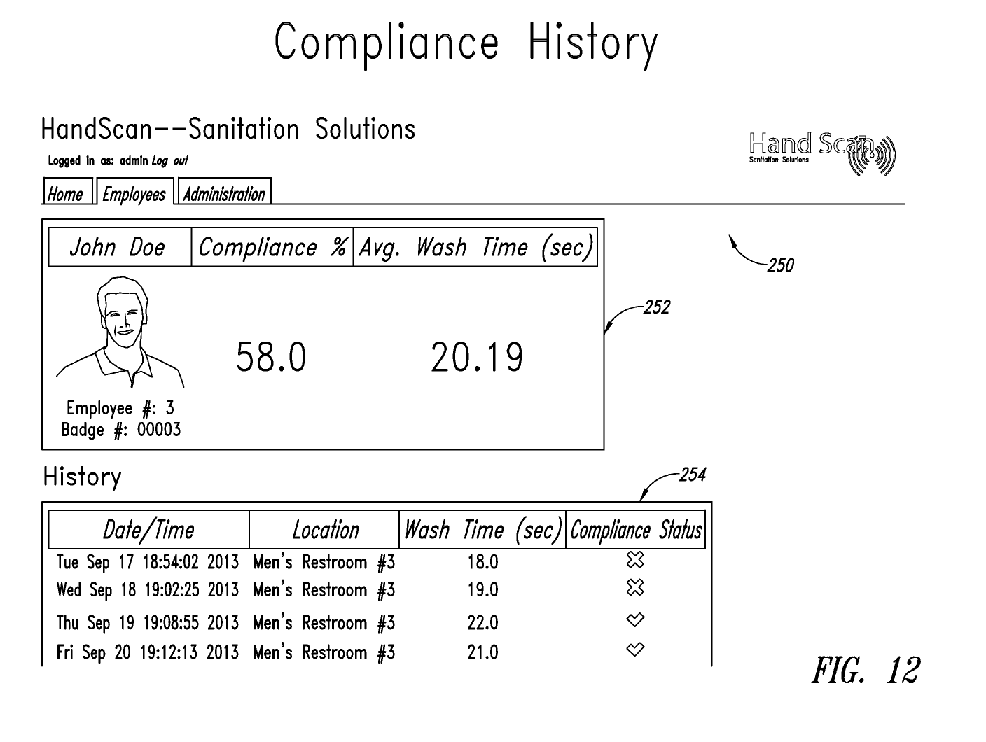

FIGS. 7 and 8 illustrate front and rear layout views of an alternative RFID antenna 120 for use with the RFID fabric tag 90 in accordance with the present disclosure. In this design, the antenna 120 consists of conductive metal thread 122 sewn or woven on a fabric patch 124. The thread 122 is repeatedly looped through the fabric patch 124 so that the loops appear on the front side 126 and rear side 128 of the fabric patch 124. Each loop 130 is adjacent a preceding and subsequent loop so that the loops are tightly formed next to each other. The loops 130 form a pattern 132 on the fabric patch 124 that is configured to function as an RFID antenna for use on fabric used on clothing that is worn and used on the human body. In this design, the pattern 132 consists of a single continuous conductive element having three vertical legs 134 on the left side and three vertical legs 136 on the right side and a horizontal cross piece 138 bridging the two legs 134, 136. More particularly, the horizontal cross piece 138 is formed as part of the interior leg 140, 142, of each of the three vertical legs 134, 136.

FIG. 8 shows the rear side 128 of the fabric patch 124 where the pattern 132 of conductive threaded loops 130 is shown in mirror image to that of FIG. 7. Also shown on this side of the fabric patch 124 is an RFID circuit 142 coupled to the RFID antenna 120. The connection between the RFID circuit 142 and the antenna 120 can be by inductive coupling or by direct wire, although due to the flexing and bending of the fabric, inductive coupling is preferred. The RFID circuit 142 may be encapsulated in a protective coating or pouch to protect it from the elements as well as repeated washing and drying under a variety of temperatures as described above.

Both embodiments of the fabric tag can be worn in close proximity to the human body, such as on clothing or outer apparel worn over clothing. The RFID fabric tags are detuned when they are not in close proximity to the human body. For maximum performance and read range, the RFID fabric tags are incorporated into the clothing to be worn over the chest or in the collar adjacent the neck or upper back. In the latter case, a reader would be located above the user, such as in a ceiling, door frame, light fixture, or other elevated location in a structure.

In accordance with another aspect of the present disclosure, an RFID tag is configured to be worn on the user's clothing or integrally formed with the user's clothing and includes an antenna configured to be RF coupled to the user's skin. A corresponding interrogator or reader is configured to detect the presence of the RFID tag when RF coupled to the skin of the user and to activate the RFID tag when the RFID tag is within an activation area.

As will be appreciated from the foregoing, the novel RFID tag can be used in a monitoring system that includes an RFID tag configured to be worn on clothing or integrally formed with the clothing and having an antenna configured to be RF coupled to the skin of the employee. The system also includes at least one reader or interrogator configured to detect the presence of the RFID tag when RF coupled to the skin of the employee and to activate the RFID tag when the RFID tag is within an activation area. Preferably, the system further includes a skin disinfectant medium dispenser configured to dispense the disinfectant medium and to transmit a dispensing signal in response to dispensing the disinfectant medium, and a remote processor and associated memory with user interface coupled to the at least one reader, the at least one activation device, and the dispenser and configured to store data related to employee identification, location of wash station, compliance rate, wash time, average wash time, and compliance status, and to process the data to enable employer management of employee hand washing. A detail description of a representative embodiment of such a system is provided below.

### Representative Application of the RFID Name Tag and Fabric Tag

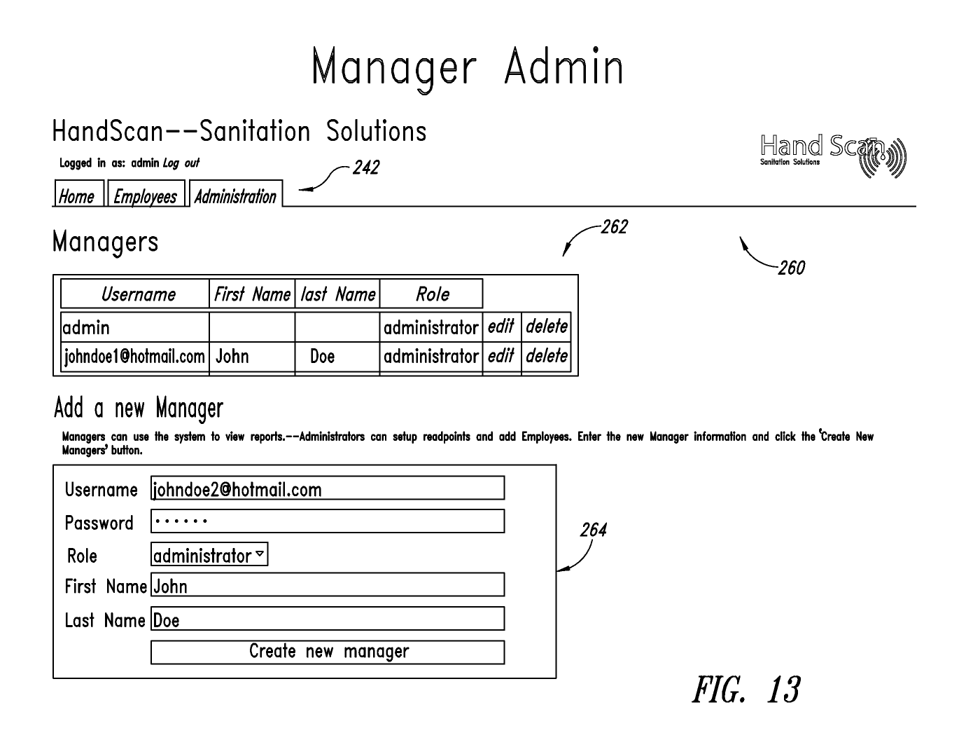

FIG. 9A illustrates a hand washing monitoring system 200 formed in accordance with one aspect of the present disclosure. The system 200 includes the RFID name tag or fabric tag 202 on clothing 204 worn by a user 206. An interrogator 208 is located near a hand washing station 210 and sufficiently close to the sink 212 to enable radio frequency communication with the tag 202. The interrogator 208 is configured to communicate with a computer processing system 214, either directly with a wired connection 216 or a radio frequency system 218 or both. The wired connection 216 can include communication over a network of computers, such as the internet.

The tag 202 is configured in accordance with the tags described herein, either as the RFID name tag 40 shown in FIGS. 3 and 4 or the RFID fabric tag 90 shown in FIGS. 5-6. When used with the hand washing station 210, the tag 202 and interrogator 208 are positioned no more than 4meters apart. The preferred range of communication in this configuration is between 3 meters to and including 6 meters. Although the tag 202 is used on or near the user's body, the antenna configuration and RFID circuit design are such that the antenna will resonate at the desired frequency in order to establish communications with the interrogator 208. Thus, when the interrogator 208 sends an interrogation signal 220, the tag 202 backscatters a responsive signal 222.

Once the interrogator 208 receives the responsive signal 222, it processes it for transmission to the computer processing system 214, which can include a microprocessor 224 and associated memory 226. The tag 202 in this application would include information about the identity of the user 206, such as the name, employee number, and badge number (if applicable) or clothing ID number (if applicable). This data is transmitted via the backscattered signal 222 to the interrogator 208 by the tag 202 in response to the interrogation signal 220. The interrogator 208 in turns provides this information to the computer processing system 214 along with additional date. This additional data can include without limitation one or more of the following: date, time, hand washing station location, duration of hand washing, duration of stay, whether soap was dispensed, hand drying time, and water turn on and turn off times or water use duration.

Proximity or presence can be determined through an analysis by a computer processor coupled to the interrogator 208 of a signal strength or RF phase characteristic of the backscatter signal from the RFID tag.

The sensing of soap dispensing, water use time, and hand drying time can be accomplished with conventional sensors associated with a soap dispenser, water faucet, and electric hand dryer. These sensors can be hard wired to the interrogator 208 for collection of the afore-mentioned data. Because this sensing is within the level of one of skill in this art, no further detailed explanation is deemed necessary.

Currently there is no monitoring program that records washing time suggested by the FDA and the CDC by RFID. In accordance with a further aspect of the present disclosure, a hand scan program is provided that has a 20 second software-timed monitoring of hand washing. The time recording software starts when an employee steps up to the sink to start washing his/her hands. Once the employee steps up to the sink to wash their hands, a twenty second alert will start. After twenty seconds wash is completed a temporal alert will be provided, such as a light, a sound, or a display or any combination of the foregoing will be broadcasted, thus alerting the employee that his or her hands have been washed the proper length of time. The alert may be a digital time display on a LED sign, counting down from 20 seconds and or a LED projected on the sink mirror. A sound tone or voice could also be used.

The computer processing system 214 utilizes the data received from the interrogator 208 to provide reports for management and users. More particularly, the microprocessor 224 stores the received data in the memory 226 and prepares various reports as requested by system users. By way of example, FIGS. 8-12 are illustrations of screen shots showing the data the system 214 can provide. The computer processor can be configured to provide audio or visual feedback to the user indicating compliance with hand washing procedures in response to input from the first and second sensors described below in connection with FIG. 9B.

FIG. 9B illustrates a more preferred system 280 in which components identical to those of FIG. 9A are referred to with the same reference numbers. In this system 280, the monitoring components are mounted in the ceiling 282 above the hand washing station 210. The interrogator 208 is positioned on the ceiling 282, either on the bottom of the ceiling panel or on the top of the ceiling panel out of sight, and oriented to detect the presence of the user 206 in the vicinity of the station 210 or when they enter the facility.

Ideally a ceiling antenna 284 coupled to the interrogator 208 is located out of sight above the ceiling 282 as shown. The ceiling antenna works above ceiling tile, drywall, concrete, tile, and most building products. The ceiling antenna comes in lengths of three feet, five feet, and seven feet. These antennas can be coupled together to extend over seven feet if needed. A seven foot ceiling antenna can cover a counter with 4 sinks 212. In a referred application, an eight inch wide antenna strip is utilized. When ceiling tile is in place, the ceiling antenna 284 will not be seen by others. Preferably the antenna 284 is a NeWave™ antenna is commercially available from Synergy RFID, Inc. in the United States. This antenna uniquely creates a cylindrical pattern illuminating uniformly the entire length of the antenna, filling the entire volume of the surrounding space as defined by the user. This design reads all RFID tags in the targeted zone while not reading extraneous tags outside the zone.

The ceiling antenna 284 is positioned to run parallel with the sink counter. Ideally one ceiling antenna will detect an individual wearing the ID tag 202 walking into a restroom or approaching the sink station 210. For example, the system will be configured to detect the identity of an individual (employee) 206 wearing an RFID tag 202 when the individual enters the area.

In most cases when an employee enters a restroom, they will proceed to a toilet area. The ceiling antenna 284 range is limited to the area around the station 210 or around the entrance exit door or both the station 210 and the entrance and exit door. Once an employee proceeds to the toilet area, the antenna 284 will stop detecting or reading the RFID tag 202. When the employee 206 walks toward the station 210 or the exit door, the ceiling antenna 284 interrogates or reads the employee's RFID tag 202 within three to four feet in front of the station 210 or the sink 212.

When the interrogator 208 detects the RFID tag 202, it will activate or energize a soap dispensing sensor 228 and a hand wash unit that includes a hand wash motion sensor 231 and LED spotlight 233. Thus, when an employee 206 walks into the ceiling antenna zone, the sensors 228 and 231 as well as the LED spotlight 233 on the ceiling will be ready to activate.

When the employee 206 reaches out for a soap dispenser 286, the motion or infrared sensor 228 will sense or detect the employee's movement and the system will record soap dispenser usage. At the same time the employee's RFID tag serial number will be recorded. The system will match the name of employee 206 with a number of the tag 202 and record this in a database.

When the employee's hands are placed in sink, the sink sensor 231 located on the ceiling will start recording hand washing. The system or the sink sensor 231 will initiate activation of a red or cool white high intensity LED spotlight 233 projecting down on the sink 212 and the user's hands as they are being washed. The LED spotlight 233 will continue to beam a narrow (8-12 inch beam) down into the sink 212 an amount of time specified by the manager of the system, such as a restaurant owner. Proper hand wash compliance established by the CDC and FDA is 20 seconds.

If the employee 206 does not use soap or does not wash their hands with soap for the required time management has set, for example 20 seconds, the system software is designed to record noncompliance. The amount of time, date, hour and minute of hand washing is recorded and made available to management through a screen display, paper report, or other notification means. Hand wash compliance will be completed when soap is applied and a 20 second (or such time interval that management has established) water wash is completed. The system is configured to enable the management of the system to alter the time interval to be more or less than 20 seconds.

Two kinds of sensors 228, 231 to read hand washing and soap dispenser usage can be used, either a digital pyroelectric infrared (PIR) motion detector or an infrared optical range sensor. A proximity sonar sensor could be used, but it is the least functional for this described use. A digital pyroelectric infrared motion detector module designed to detect infrared radiation (IR) from a moving human or animal both in daylight and at night is preferred. It will only respond to a moving source of infrared radiation. It will not detect a static IR source. Preferably a module is used that includes a digital pyroelectric infrared sensor, a microprocessor and a relay driver. An on-board voltage regulator powers the circuits and accepts a 4 to 15.5 volt DC power supply voltage.

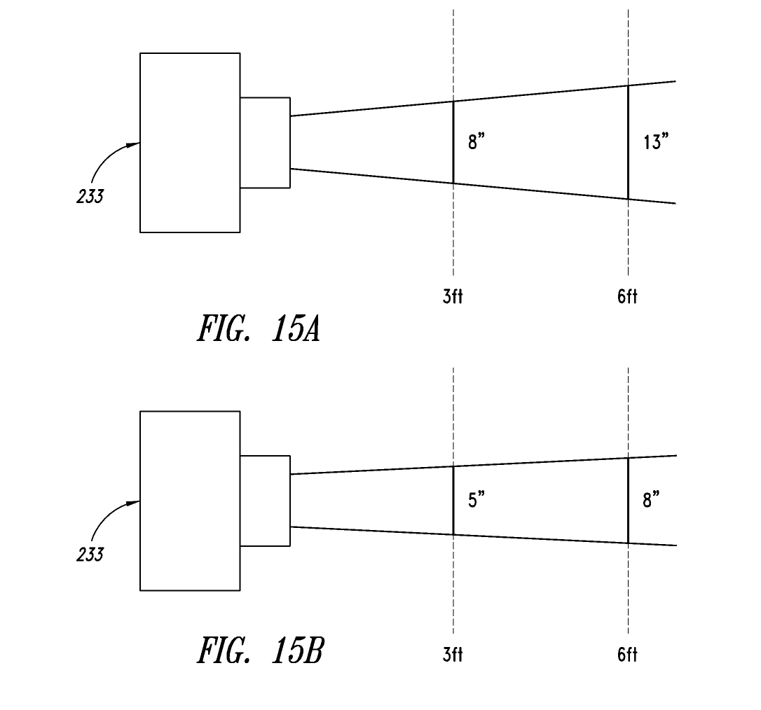

The high intensity LED spotlight 233 is preferably a custom made 1 watt, 85-100 Lumens, LED mounted in a lightweight aluminum housing obtained from the Oznium company in Colorado. The front face of the housing is concave with the LED light emitter positioned at the bottom center of the face. The beam angle of the lens can have a range from 5 degrees to 25 degrees. Alternatively, an adjustable lens that is able to achieve an 8 inch spot at six feet could be used, although the dimensions of the housing would be much taller, requiring a larger housing. Either a red or cool white LED light can be used that is narrowly directed as shown in FIGS. 15A-B. The LED spotlight 233 is used as a time gauge to alert employees and remind them to vigorously wash their hands continuously while the light is illuminated. Employees will understand that walking away from the sink while the LED light 233 is still illuminated will be a violation of company hand washing compliance. As such the timed LED spotlight is a tool to help employees remember to comply with health and safety standards.

In one aspect of the present disclosure, the hand washing sensor 231 and the LED spotlight 233 are mounted in the same housing that is in turn mounted on the ceiling over the sink 212.

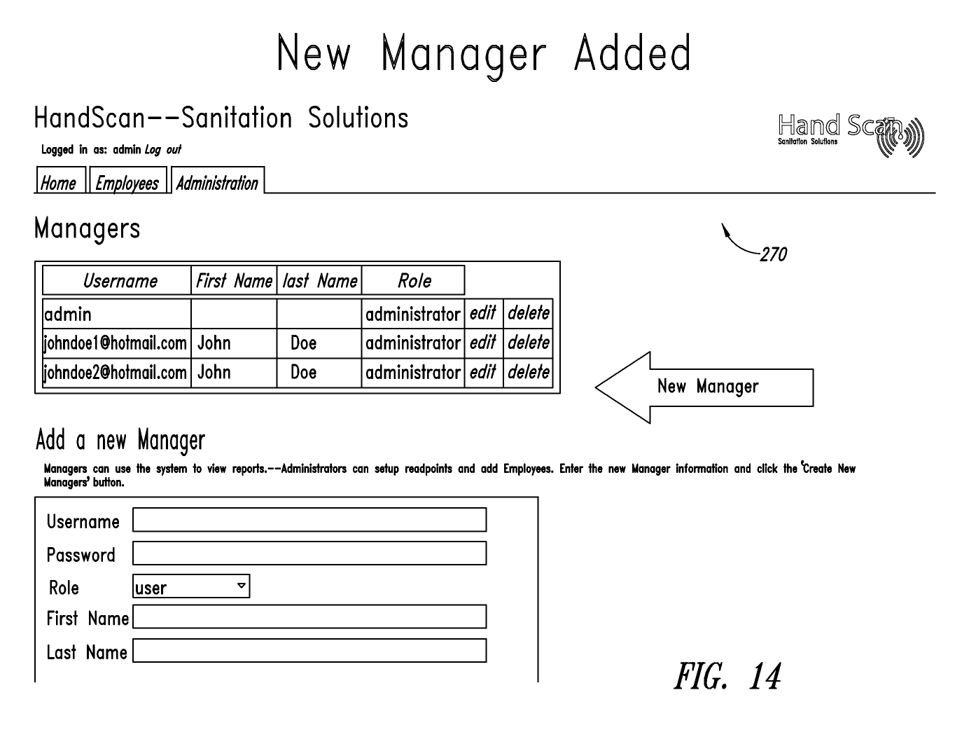

FIG. 10 shows a sample log-in screen 230 in which a user enters their user name and password to access the data. FIG. 11 illustrates a representative display of an Employee Summary Screen 240. Tabs 242 enable selection between a home screen and an administration screen as well as the employees screen. The Employees are shown listed in table form 244. In this case each employee is listed in their own row, with the columns provided for Last Name, First Name, Badge ID, Image, and Compliance Rate. Additional columns are provided for additional data, such as that listed above, i.e., without limitation one or more of the following: date, time, hand washing station location, duration of hand washing, duration of stay, whether soap was dispensed, hand drying time, and water turn on and turn off times or water use duration.

FIG. 12 is the Compliance History Screen 250 that can be selected from the prior screen by clicking on an individual employee. In the Compliance History screen 250 data in a summary box 252 may include Compliance percent, Average Washing Duration, as well as a detailed history 254 showing Date/Time, Location, Wash Time (seconds) and a Compliance Status, such as whether the employee washed their hands for a required length of time.

FIG. 13 is the Manager Administration screen 260 selected from the upper tabs 242. Here, the names of managers are displayed in the Managers table 262, which includes Username, First name, Last name, and Role. In addition, an Add a New Manager box 264 is provided for adding a new manager to the system.

FIG. 14 shows the New Manager Added screen 270 in which is shown the addition of a new manager to the system from the previous screen in FIG. 13.

From the foregoing it will be appreciated that, although specific embodiments of the invention have been described herein for purposes of illustration, various modifications may be made without deviating from the spirit and scope of the present disclosure. Accordingly, the disclosure is not limited except as by the appended claims and the equivalents thereof.

1. A system for monitoring hand washing at a hand washing station having a sink and a soap dispenser, comprising:
an interrogator located in a ceiling in proximity to the hand washing station and configured to transmit interrogation signals and to receive responsive backscattered signals and to transmit data signals to the processor and the memory;
a first sensor located in the ceiling above the soap dispenser and structured to detect the presence of the user's hands in close proximity to the soap dispenser;
a second sensor located in the ceiling above the sink and structured to detect the presence of the user's hands in close proximity to or in the basin of the sink;
an LED light located on the ceiling above the sink and structured to visibly illuminate the sink for an interval of time in response to detection of the user by the second sensor;
an RFID tag configured to be worn on or in close proximity to a user's body, the tag including:
a radio frequency circuit configured to receive and modulate an interrogation signal for backscatter transmission; and
an antenna configured to resonate in response to the interrogation signal when in close proximity to the human body; and
a computer processor coupled to the interrogator and configured to receive the data signals from the interrogator to determine a presence of the user and to process the same and generate reports pertaining to use of the hand washing station by users, the computer processor further coupled to the LED light and configured to control the interval of time the LED light illuminates the sink.

2. The system of claim 1 wherein the RFID tags are UHF passive RFID tags integrated into badges worn the user.

3. The system of claim 1 wherein the RFID tags are UHF passive RFID tags integrated in to clothing worn by the user.

4. The system of claim 1 wherein the first and second sensors for determining a user's proximity to the sink and the soap dispenser are operatively coupled to the computer processor, and the computer processor is configured to receive signals from the first and second sensors and determine the user's compliance with hand washing procedures.

5. The system of claim 1 wherein the computer processor is configured to provide audio or visual feedback to the user indicating compliance with hand washing procedures in response to input from at least the first and second sensors.

6. The system of claim 5 wherein compliance is determined by the computer processor by detection of the user by the first sensor in the proximity of the soap dispenser and detection of the user by the second sensor in the proximity of the sink during the interval of time the LED light is illuminated.

7. The system of claim 6 wherein the computer process is configured to provide audio or visual feedback to the user indicating compliance.

8. The system as recited in claim 2 wherein proximity is determined through an analysis by the computer processor of a signal strength or RF phase characteristic of the backscatter signal from the RFID tag.

9. The system as recited in claim 1 wherein the RFID tag is programmed with a unique identifier associated with a particular user, allowing compliance data to be collected for identified users.

10. The system of claim 1 wherein the RFID tag is not programmed with a unique identifier, allowing privacy protection and compliance data to be collected for a group of users in a non-personally identifiable manner.

11. The system of claim 1 wherein presence or proximity is determined through an analysis by the computer system of inputs from the first and second sensors in which the first and second sensors comprise one or more of an infrared distance measuring sensor, an ultrasonic distance measuring sensor, and a laser range measuring sensor.

12. The system of claim 1 wherein upon determination by the computer processor of a user's compliance data for a hand washing event, the compliance data is evaluated by a networked data storage and reporting system and a message is sent to predesignated recipients when a non-compliant event occurs.

13. The system of claim 12 wherein the message takes the form of an email.

14. The system of claim 12 wherein the message takes the form of an SMS message.

15. A system for monitoring hand washing compliance, comprising:
a plurality of sensors installed in a space to detect the presence of or proximity of personnel to key areas; and
a controller operatively coupled to the sensors, the controller being programmed to analyze sensor inputs to determine if personnel are washing their hands in a manner compliant with a set of requirements, and a networked data storage and reporting system operatively coupled to the controller and configured to provide reports of hand washing compliance.

16. The system of claim 15 wherein the sensors are installed on a ceiling over the space.

17. The system of claim 15 comprising an LED light configured to illuminate a hand washing area for an interval of time that begins in response to detection by one of the plurality of sensors that a user is in proximity to the sink.

18. The system of claim 17 wherein the LED light is mounted on a ceiling over the hand washing area.

19. A system for monitoring hand washing compliance by a user at a wash station, comprising:
an RFID tag configured to be worn on the user's clothing or integrally formed with the user's clothing and having an antenna configured to be RF coupled to the user's skin;
a reader configured to detect the presence of the RFID tag when RF coupled to the skin of the user and to activate the RFID tag when the RFID tag is within an activation area;
a skin disinfectant medium dispenser configured to dispense the disinfectant medium and to transmit a dispensing signal in response to dispensing the disinfectant medium; and
a remote processor and associated memory with user interface coupled to the reader, the activation device, and the dispenser and configured to store data related to user identification, location of wash station, compliance rate, wash time, average wash time, and compliance status, and to process the data to enable management of user hand washing compliance.
